(19) United States
(12) Patent Application Publication
(10) Pub. No.: US 2026/0220204 A1
(43) Pub. Date: Jul. 30, 2026

(54) METHOD FOR DISTRIBUTING EFFECTS, COMPUTING DEVICE, MEDIUM AND PROGRAM PRODUCT

(71) Applicants: Beijing Zitiao Network Technology Co., Ltd., Beijing (CN); Bytedance Technology Ltd., Grand Cayman, KY (US)

(72) Inventors: Yuqing WANG, Beijing (CN); Xixian HAN, Beijing (CN); Tan Eu ZIN, Singapore (SG)

(21) Appl. No.: 19/431,885

(22) Filed: Dec. 23, 2025

(30) Foreign Application Priority Data
Jan. 26, 2025 (CN) 202510125356.6

(51) Int. Cl. G06F 16/903; G06F 16/9038

(52) U.S. Cl. CPC G06F 16/90335; G06F 16/9038

(57) ABSTRACT

The present disclosure provides a method for distributing effects, a computing device, a medium and a program product. The method includes: obtaining a request for a template from a first region, wherein the request comprises an identifier of an effect in the template; querying the effect in a first effect repository for the first region using the identifier of the effect; querying the effect in a second effect repository for a second region using the identifier of the effect, the second region including the first region; and sending the effect obtained from the first effect repository or the second effect repository as a response to the request.

### CROSS-REFERENCE TO RELATED APPLICATION(S)

The present disclosure claims the priority from Chinese patent application No. 202510125356.6 entitled “METHOD AND APPARATUS FOR DISTRIBUTING EFFECTS, COMPUTING DEVICE, MEDIUM AND PROGRAM PRODUCT” filed on January 26, 2025, the disclosure of which is hereby incorporated by reference in its entirety.

### FIELD

The present disclosure relates to the technical field of computers, and more specifically, to a method and an apparatus for distributing effects, a computing device, a computer-readable storage medium and a computer program product.

### BACKGROUND

User-Generated Contents (UGCs) refer to various forms of contents (e.g. text, pictures, audios, videos and the like) created and published by users on Internet platforms. The contents are generally generated by users based on their interests, experiences, perspectives or creative ideas. To enhance the quality of the UGC, the users often add to the created contents various effects including text effects, image effects, video effects and the like.

Multiple effects can be organized into a template with which users can improve the efficiency and quality of content creation. Such template can be shared among users. However, regional restrictions applied to effects within templates may prevent the template from being properly utilized when shared across different regions, posing challenges for the distribution of both templates and effects.

### SUMMARY

In a first aspect of the present disclosure, there is provided a method for distributing effects. The method includes: obtaining a request for a template from a first region, wherein the request comprises an identifier of an effect in the template; querying the effect in a first effect repository for the first region using the identifier of the effect; querying the effect in a second effect repository for a second region using the identifier of the effect, the second region including the first region; and sending the effect obtained from the first effect repository or the second effect repository as a response to the request.

In a second aspect of the present disclosure, there is provided an apparatus for distributing effects. The apparatus includes: a request obtaining unit configured to obtain a request for a template from a first region, wherein the request comprises an identifier of an effect in the template; a first querying unit configured to query the effect in a first effect repository for the first region using the identifier of the effect; a second querying unit configured to query the effect in a second effect repository for a second region using the identifier of the effect, the second region including the first region; and a sending unit configured to send the effect obtained from the first effect repository or the second effect repository as a response to the request.

In a third aspect of the present discourse, there is provided a computing device, comprising: at least one processing unit; and at least one memory coupled to the at least one processing unit and storing thereon instructions executable by the at least one processing unit, wherein the instructions, when executed by the at least one processing unit, cause the computing device to perform the method in the first aspect of the present disclosure.

In a fourth aspect of the present disclosure, there is provided a non-transitory computer storage medium, comprising machine-executable instructions that, when executed by a device, cause the device to perform the method in the first aspect of the present disclosure.

In a fifth aspect of the present disclosure, there is provided a computer program product comprising machine-executable instructions that, when executed by a device, cause the device to perform the method in the first aspect of the present disclosure.

The Summary is to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

With reference to the following detailed description of the accompanying drawings, the above and other objectives, features, and advantages of the embodiments of the present disclosure will be made clearer. In the drawings, multiple embodiments of the present disclosure are depicted in an exemplary, but non-limiting, way, where:

FIG. 1 illustrates a schematic diagram of an example environment where embodiments of the present disclosure can be implemented;

FIG. 2 illustrates a schematic diagram of an implementation of cross-region effect isolation according to embodiments of the present disclosure;

FIG. 3 illustrates a schematic diagram of an implementation of cross-region effect distribution according to embodiments of the present disclosure;

FIG. 4 illustrates a schematic diagram of a process of distributing effects according to embodiments of the present disclosure;

FIG. 5 illustrates a schematic flowchart of a method for distributing effects according to embodiments of the present disclosure;

FIG. 6 illustrates a block diagram of an apparatus for distributing effects according to embodiments of the present disclosure; and

FIG. 7 illustrates a schematic block diagram of an electronic device that can implement multiple embodiments of the present disclosure.

Throughout the drawings, the same or similar reference numerals represent the same or similar elements.

### DETAILED DESCRIPTION OF EMBODIMENTS

Reference now will be made to multiple example implementations to describe the present disclosure. It would be appreciated that those implementations are described to enable those skilled in the art to better understand and thus carry out the present disclosure, without implying any limitation to the scope of the present disclosure.

Prior to applying the technical solution, in accordance with the relevant laws and regulations, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user’s personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

Reference below will be made to describe the embodiments of the present disclosure in detail. Although some embodiments of the present disclosure are depicted in the drawings, it would be appreciated that the present disclosure could be implemented in various forms and should not be construed as being restricted to the embodiments described herein. Rather, those embodiments are provided to enable a more thorough and complete understanding of the present disclosure. It is to be understood that the drawings and embodiments of the present disclosure are provided only exemplarily, but not used to limit the protection scope of the present disclosure.

As described herein, the term “includes” or similar expressions are to be read as open-ended terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

Editing an audio or video typically involves calling online effect resources (hereinafter abbreviated as “effects” or “resources”). Due to regional characteristics of effect resources (for example, text effects depend on a local language), effect resources of different regions (e.g., different countries or different geographical areas) are independent from one another. Users can only obtain effect resources from a local effect repository to create contents. In the template-based scenario, there may arise some problems if a template including a group of effects is applied across regions, specifically: some effects in the template are unavailable due to cross-region restrictions, causing the template to be filtered out, or making it impossible for users to obtain all the effects in the template. This builds a barrier against the application of the template across different regions, affecting the flexibility and efficiency of audio and video editing.

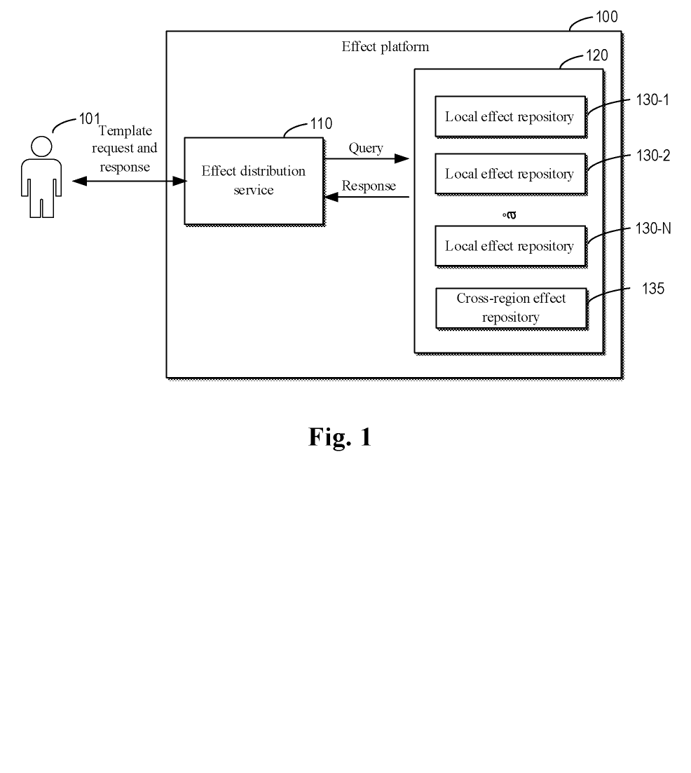

In view of the above, the embodiments of the present disclosure provide a technical solution for distributing effect resources across regions. In some embodiments, a region (for example, including one or more existing geographical regions) is created on the distribution platform for effect resources, to allow effects to be distributed across regions to be configured to the created region, and a corresponding effect repository is built to synchronize the effects to the effect repository. If an effect cannot be obtained from the local effect repository, it can be obtained from the effect repository built for the created region. This approach enables cross-regional distribution of effects within a template. Reference below will be made to FIGS. 1-7 to describe in detail the embodiments of the present disclosure.

FIG. 1 illustrates a schematic diagram of an environment where the embodiments of the present disclosure can be implemented. As shown therein, the user 101 can send a template request to an effect platform 100 and receive a response from the latter. The effect platform 100 can be provided by an audio and video editing application, or other application with a capability of generating User Generated Content (UGC), which can run on a cloud server or any other computing device. The template request may include an identifier of the template, and information of effects within the template. For example, the template request may indicate, or include, one or more pieces of information that can uniquely identify an effect, for example, a resource identifier (resource ID). In some implementations, information of effects include identifier information of a panel which refers to a set of effects of the same category, including, but not limited to, a filter, a font, a sticker, a mask, a transition, or the like.

The effect platform 100 includes an effect distribution service 110 and an effect database 120. The effect distribution service 110 receives a template request from a user 101, parses the template request, and obtains information of an effect in the template and region information. Thereafter, the effect distribution service 110 queries a corresponding effect in the effect database 120 using the information of the effect obtained through parsing (e.g., the region information, the resource identifier and the panel identifier). It is to be understood that, for a given template request, it is only permitted to query an effect in a region-specific effect repository (also referred to as local effect repository) corresponding to the region of the template request while not permitted in effect repositories in other regions, to achieve cross-region effect isolation.

The resource repository 120 includes a local effect repository for one or more regions (one of the regions may be called “first region”), including an effect repository 130-1, an effect repository 130-2 … and an effect repository 130-N (collectively referred to as local effect repository 130 or first effect repository 130). The first effect repository 130 can store effect resources and provide effect management. In some embodiments, in the first effect repository 130, the effects can be divided into groups by panel such that effects can be queried based on identifier information of panels and resource identifiers of effects. The first effect repository 130 may include common effects that are available in any region, and that are generally set as default effects. The first effect repository 130 may further include region-specific effects that have regional restrictions, for example, text effects for a language of a country or region.

The effect repository 120 further includes a second effect repository 135 for a second region that may include one or more regions. The cross-region effect repository 135 may be called second effect repository 135. The effects in the first effect repository 130 may be configured to be associated with the second region. Meanwhile, the related information (e.g., panel information) of the effects can be synchronized to the cross-region effect repository 135. For example, an administrator may select effects to be configured to the second region, in particular region-specific effects. Alternatively, a group of effects can be configured to the second region according to the granularity of the panel. In some embodiments, if an effect is configured to the second region, the effect cannot only be queried in the first effect repository 130, but can also be queried in the cross-region effect repository 135. Queries in the first effect repository 130 and the cross-region effect repository 135 can be performed in any order, or can be executed concurrently. In some embodiments, the cross-region effect repository 135 may store resources of effects configured to the second region, or may not store the resources but contains links to the resources of effects.

If an effect is found in the local effect repository 130 or the cross-region effect repository 135, the effect distribution service 110 can obtain the effect from the effect database 120 as a response to the query. Otherwise, the effect database 120 can send a query failure response to the effect distribution service 110.

If the effect distribution service 110 can obtain all the effects in the template request from the effect database 120, the effect distribution service 110 can send the template including all the effects for use by the user 101. However, if there is any effect unable to be obtained from the effect database 120, it can be considered that the template is unavailable, and the user is informed of the result. In some embodiments, the unavailable template is not displayed to the user.

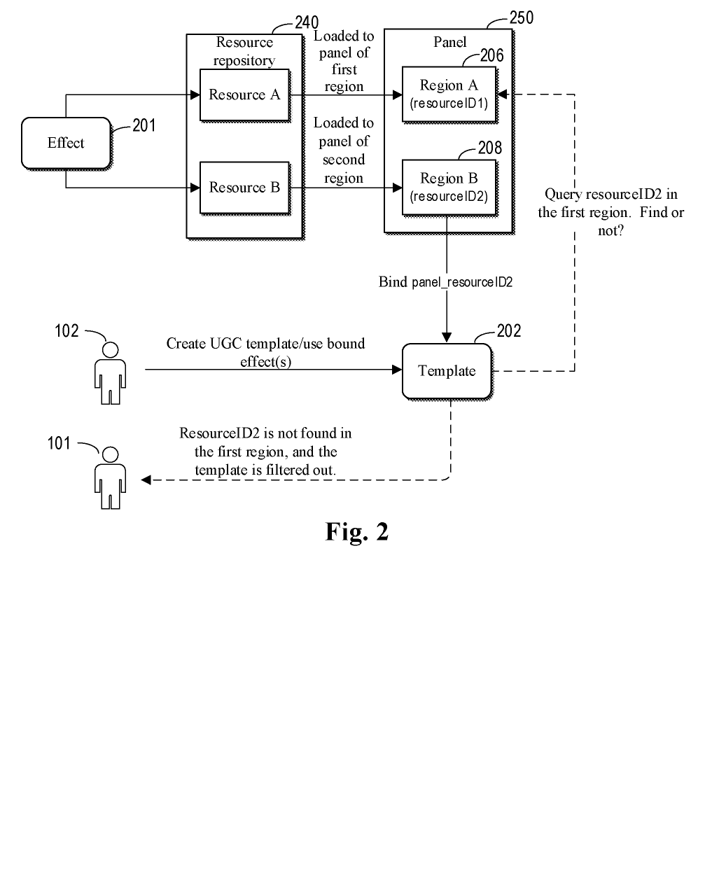

FIG. 2 illustrates a schematic diagram of an implementation of cross-region effect isolation according to embodiments of the present disclosure, where users in a region cannot use template created and shared by users in another region.

As shown therein, the user 101 is located in the region A, the user 102 is located in the region B, the user 102 creates a template 202 and is bound with one or more effects, and the user 101 desires to use the template 202. Then, due to the regional restrictions of effects, some effects in the template 202 cannot be distributed to the user 101. Hereinafter, description will be made with an effect 201 in the template 202 as an example.

The effect 201 is uploaded to the resource repository 240. For different regions, the effect 201 is uploaded as a resource A for a region A and a resource B for a region B. The resource repository 240 may be part of the effect database 120, or may be an external database accessible by the effect database 120. For example, the resource A belongs to the effect repository 130-1 of the region A, and the resource B belongs to the effect repository 130-2 of the region B. Then, the resource A and the resource B are loaded to a panel 250 which includes a panel 206 of the region A and a panel 208 of the region B. For example, if the effect 201 is a font effect, the effect 201 can be loaded to the font panel. In response to loading, the panel 206 of the region A includes a resource identifier resource ID1 of the effect 201, and the panel 208 of the region B includes a resource identifier resource ID2 of the effect 201, where resourceID1 is different from resourceID2.

The user 102 creates a template 202 that includes the effect 201. The user 102 is located in the region B, uses the resource identifier (i.e., resourceID2) of the effect 201 in the corresponding effect repository, and is bound to the template 202. Optionally, the resourceID2, together with the identifier information of the panel, is bound to the template 202.

With the intention to use the template 202, the user 101 in the region A sends a template request to the effect platform 100 to request for effect resources in the template 202. As mentioned above, the effect distribution service 110 parses the template request, identifies that the template request is from the region A, and therefore limits the queries for the effect 201 in the effect repository of the region A, specifically queries for resourceID2 in the panel 206. However, the effect repository of the region A does not contain resourceID2, and the user thus cannot obtain the effect 201, causing the template 202 to be unavailable.

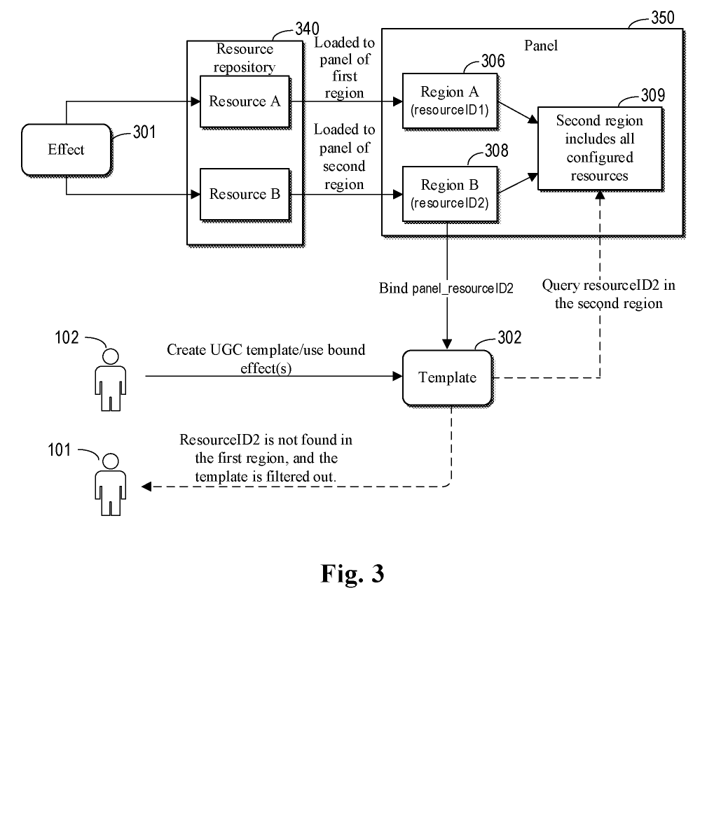

FIG. 3 illustrates a schematic diagram of an implementation of cross-region effect distribution according to embodiments of the present disclosure, where a second region is created, and effects are configured to the second region to enable users to access the effects across regions.

The user 101 is located in the region A1, the user 102 is located in the region B, the user 102 creates a template 302 and is bound with one or more effects, and the user 101 desires to use the template 302. Hereinafter, description will be made on cross-region effect distribution with an effect 301 in the template 302 as an example.

The effect 301 is uploaded to the resource repository 340. For different regions, the effect 301 is uploaded as a resource A for a region A and a resource B for a region B. Then, the resource A and the resource B are loaded to a panel 350 which includes a panel 306 for the region A and a panel 308 for the region B. In response to loading, the panel 306 of the region A includes a resource identifier resourceID1 of the effect 301, and the panel 308 of the region B includes a resource identifier resoruceID2 of the effect 301, where resourceID1 is different from resourceID2.

In order to implement cross-region effect distribution, the effect 301 can be configured to the second region. In some embodiments, the panel where the effect 301 is located can be configured to the panel 309 of the second region, where all the effects in the panel are configured to the panel 309 of the second region. In addition or alternatively, the effect 301 or other effects can be configured separately to the panel 309 of the second region. In response to the effect 301 being configured to the second region, the resource identifiers resourceID1 and resourceID2 of the effect 301 are synchronized to the second effect repository of the second region. Accordingly, the second effect repository includes all the configured effect resources.

With the intention to use the template 302, the user 101 in the first region (e.g., the region A) sends a template request to the effect platform 100 to request for effect resources in the template 302. The effect distribution service 110 parses the template request, identifies that the template request is from the first region, and queries the effect 301 in the effect repository of the first region (i.e., it queries resourceID2 in the panel 306). In addition, the effect distribution service 110 can determine whether the effect 301 is configured to the second region. If yes, the effect distribution service 110 can query resourceID2 in the second effect repository. In the example, although not found in the effect repository of the first region (e.g. the panel 306), resourceID2 can be obtained in the corresponding panel 309 of the second effect repository. As such, the effect 301 can be obtained from the second effect repository to implement cross-region effect distribution.

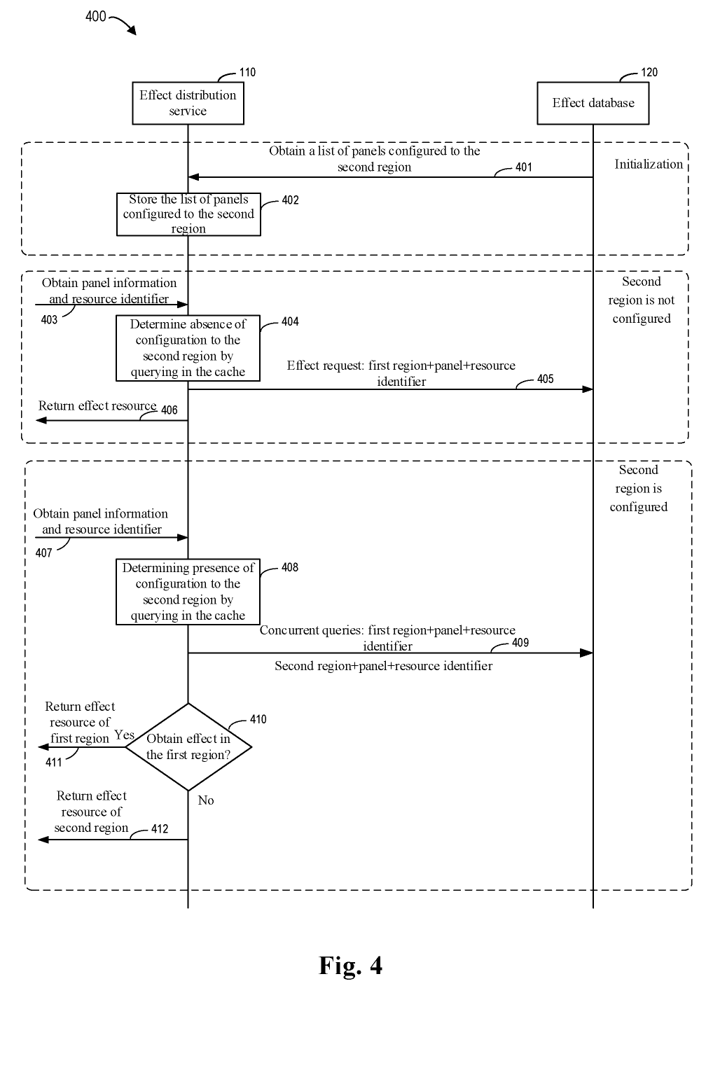

FIG. 4 illustrates a schematic diagram of a process 400 for distributing effects according to embodiments of the present disclosure. The process 400 involves the effect distribution service 110 and the effect database 120. In general, the process 400 includes an initialization phase (steps 401 and 402), distribution of effects not configured to the second region (steps 403 through 406) and distribution of effects configured to the second region (steps 407 through 412). It is worth noting that some steps in the process 400 may be omitted or executed separately, and the process 400 may include other steps not shown.

In step 401, the effect distribution service 110 obtains a list of panels configured to the second region from the effect database 120. In some embodiments, the effect distribution service 110 can periodically pull a list of panels configured to the second region from the effect database 120. In step 402, the effect distribution service 110 stores the list of panels configured to the second region.

Steps 403 through 406 involve distribution of effects that are not configured to the second region. In step 403, the effect distribution service 110 receives a template request from the first region, and obtains panel information and a resource identifier of an effect. In step 404, the effect distribution service 110 determines that the effect is not configured to the second region by querying the effect in the cache. In step 405, the effect distribution service 110 sends an effect request to the effect database 120, where the request includes first region information, panel information and a resource identifier. The effect distribution service 110 can receive a response to the effect request, and if the effect is found, the response includes an effect resource. In step 406, the effect distribution service 110 returns the effect resource as a response to the template request.

Steps 407 through 412 involve distribution of effects that have been configured to the second region. In step 407, the effect distribution service 110 receives a template request from the first region, and obtains panel information and the resource identifier of the effect. In step 408, the effect distribution service 110 can determine that the effect is configured to the second region by querying the effect in the cache. In step 409, the effect distribution service 110 concurrently sends to the effect database 120 a request for querying the effect in the first effect repository and the second effect repository. For the first effect repository, the request may include the panel information and the resource identifier of the effect, and the first region information. For the second effect repository, the request may include the panel information and the resource identifier of the effect, and the second region information. Alternatively, the two requests may not be concurrent. For example, the request may be first directed to the first effect repository, and if the effect is not found in the first effect repository, the request may be then redirected to query the effect in the second effect repository. In step 410, it is determined whether the effect is found in the first effect repository. If yes, step 411 is executed, and the effect obtained from the first effect repository is returned; if no, the effect obtained from the second effect repository is returned.

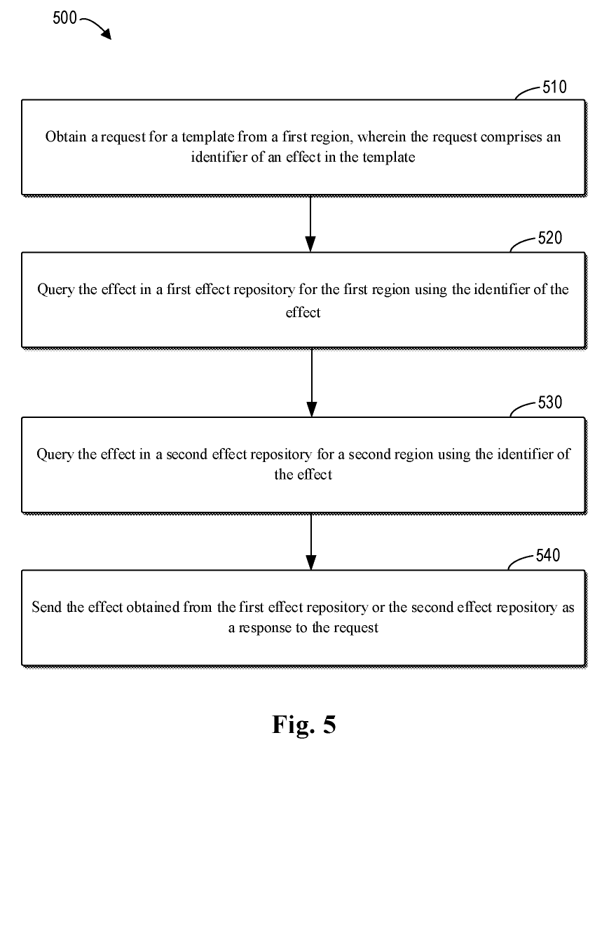

FIG. 5 illustrates a flowchart of a method 500 for distributing effects according to some embodiments of the present disclosure. The method 500 can be implemented by any device with a computing capability. For example, the method 500 can be performed by a computing device capable of running the effect platform 100, the effect distribution service 110 or the effect database 120.

The method 500 includes: in block 510, obtaining a request for a template from a first region, wherein the request comprises an identifier of an effect in the template; in block 520, querying the effect in a first effect repository for the first region using the identifier of the effect; in block 530, querying the effect in a second effect repository for a second region using the identifier of the effect, the second region including the first region; and in block 540, sending the effect obtained from the first effect repository or the second effect repository as a response to the request. The method 500 can achieve barrier-free cross-regional distribution of effects.

In some embodiments, querying the effect in the second effect repository for the second region may include: in response to the effect not being found in the first effect repository and it being determined that the effect is configured to the second region, querying the effect in the second effect repository for the second region using the identifier of the effect.

In some embodiments, the method may further include: in response to the effect not being found in the first effect repository and it being determined that the effect is not configured to the second region, determining that the template is unavailable.

In some embodiments, the method may further include: in response to the effect being found in the first effect repository, sending the effect obtained from the first effect repository as the response to the request.

In some embodiments, the template is created based on a third effect repository for a third region, the third region being different from the first region.

In some embodiments, the first effect repository and the second effect repository comprise common effects, and comprise region-specific effects, respectively.

In some embodiments, the effect is included in an effect group, the request further comprises identifier information of the effect group, and determining whether the effect is configured to the second region comprises: determining, based on a list of effect groups configured to the second region, that the effect group has a configuration for the second region; and in response to determining that the effect group has the configuration for the second region, determining that the effect is configured for the second region.

In some embodiments, the effect group comprises a panel comprising at least one of: a font, dynamic text, a filter, a sticker, a mask and a transition.

In some embodiments, querying the effect in the first effect repository for the first region comprises querying the effect in the first effect repository using the identification information of the effect group and the identifier of the effect, and querying the effect in the second effect repository for the second region comprises querying the effect in the second effect repository using the identification information of the effect group and the identifier of the effect.

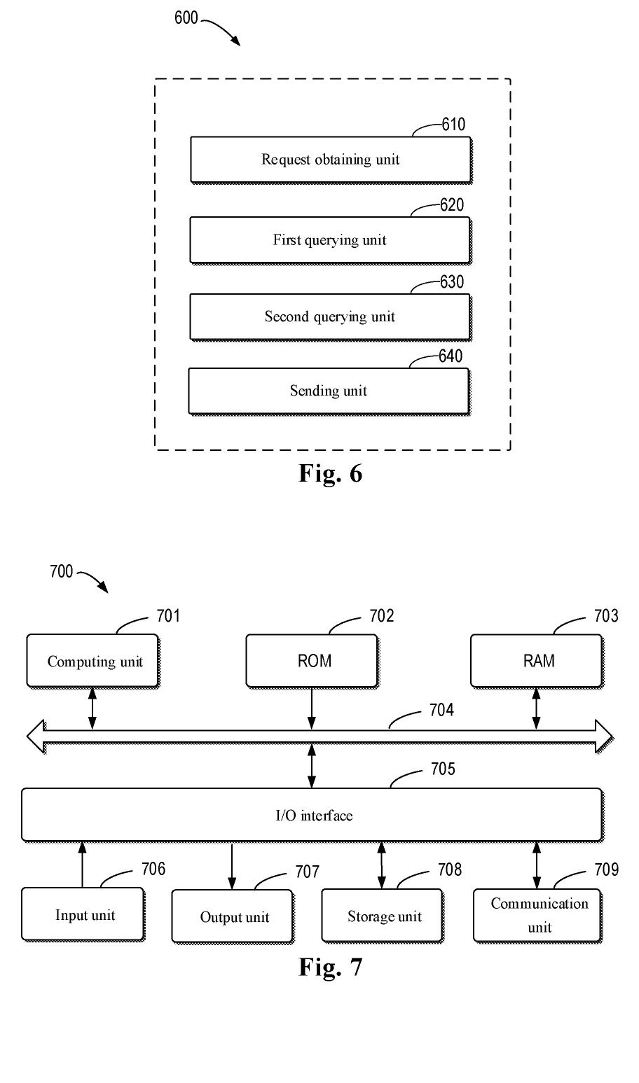

FIG. 6 illustrates a schematic block diagram of an apparatus 600 for distributing effects according to embodiments of the present discourse. As shown therein, the apparatus 600 includes: a request obtaining unit 610 configured to obtain a request for a template from a first region, wherein the request comprises an identifier of an effect in the template; a first querying unit 620 configured to query the effect in a first effect repository for the first region using the identifier of the effect; a second querying unit 630 configured to query the effect in a second effect repository for a second region using the identifier of the effect, the second region including the first region; and a sending unit 640 configured to send the effect obtained from the first effect repository or the second effect repository as a response to the request.

It is worth noting that more elements shown in FIGS. 1-5 can be implemented by the apparatus 600 in FIG. 6. For example, the apparatus 600 may include more modules or units to implement the elements described above, or some units or modules shown in FIG. 6 can be further configured to implement the elements described above. Details are omitted herein for brevity.

FIG. 7 illustrates an example block diagram of an example device 700 that can implement embodiments of the present disclosure. As shown therein, the device 700 may include a computing unit 701 which can execute various actions and processing based on programs stored in a Read Only Memory (ROM) 702 or a program loaded from a storage unit 708 to a Random Access Memory (RAM) 703. RAM 703 stores therein various programs and data required for operations of the device 700. The CPU/GPU 701, the ROM 702, and the RAM 703 are connected to one another via a bus 704. An input/output (I/O) interface 705 is also connected to the bus 704.

A plurality of components in the device 700 may be connected to the I/O interface 705, including: an input unit 706 including, for example, a keyboard, a mouse, and the like; an output unit 707 including various types of displays, loudspeakers, and the like; a storage unit 708 including, for example, a magnetic disk, a compact disc, or the like; and a communication unit 709, for example, a network card, a modem, a wireless communication transceiver, or the like. The communication unit 709 can allow the device 700 to exchange information/data with other devices through a computer network such as Internet, and/or various kinds of telecommunication networks.

The computing unit 701 may be any general-purpose and/or special-purpose processing component with processing and computing capabilities. Some examples of the computing unit 701 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), or any appropriate processor, controller, microcontroller or the like. The various methods or processes described above can be performed by the computing unit 701. For example, the method 500 may be implemented as computer software programs that are tangibly included in a machine readable medium, e.g., the storage unit 708. In some embodiments, part or all of the computer programs may be loaded and/or mounted onto the device 700 via ROM 702 and/or communication unit 709. When the computer program is loaded to the RAM 703 and executed by the computing unit 701, one or more steps or postures of the method 500 as described above can be executed. Alternatively, in other embodiments, the computing unit 701 can be configured in any other appropriate manner (e.g., by means of firmware) to perform the method 500.

In some embodiments, the method and process described above may be implemented as a computer program product. The computer program product may include a computer readable storage medium having stored thereon computer readable program instructions for performing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to corresponding computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the corresponding computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to perform aspects of the present disclosure.

These computer readable program instructions may be provided to a processing unit of a general-purpose computer, special-purpose computer, or other programmable data processing device to produce a machine, such that the instructions, when executed via the processing unit of the computer or other programmable data processing device, create apparatuses for implementing the functions/actions specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the functions/actions specified in the flowchart and/or block diagram block or blocks.

The computer readable program instructions may also be loaded onto a computer, other programmable data processing devices, or other devices to cause a series of operational steps to be performed on the computer, other programmable devices or other devices to produce a computer implemented process, such that the instructions which are executed on the computer, other programmable devices, or other devices implement the functions/actions specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the images. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A method for distributing effects, comprising:
obtaining a request for a template from a first region, wherein the request comprises an identifier of an effect in the template;
querying the effect in a first effect repository for the first region using the identifier of the effect;
querying the effect in a second effect repository for a second region using the identifier of the effect, the second region including the first region; and
sending the effect obtained from the first effect repository or the second effect repository as a response to the request.

2. The method of claim 1, wherein querying the effect in the second effect repository for the second region comprises:
in response to the effect not being found in the first effect repository and it being determined that the effect is configured to the second region, querying the effect in the second effect repository for the second region using the identifier of the effect.

3. The method of claim 1, further comprising:
in response to the effect not being found in the first effect repository and it being determined that the effect is not configured to the second region, determining that the template is unavailable.

4. The method of claim 1, further comprising:
in response to the effect being found in the first effect repository, sending the effect obtained from the first effect repository as the response to the request.

5. The method of claim 1, wherein the template is created based on a third effect repository for a third region, the third region being different from the first region.

6. The method of claim 5, wherein the first effect repository and the second effect repository comprise common effects, and comprise region-specific effects, respectively.

7. The method of claim 1, wherein the effect is included in an effect group, the request further comprises identifier information of the effect group, and determining whether the effect is configured to the second region comprises:
determining, based on a list of effect groups configured to the second region, that the effect group has a configuration for the second region; and
in response to determining that the effect group has the configuration for the second region, determining that the effect is configured for the second region.

8. The method of claim 7, wherein the effect group comprises a panel comprising at least one of: a font, dynamic text, a filter, a sticker, a mask and a transition.

9. The method of claim 7, wherein,
querying the effect in the first effect repository for the first region comprises querying the effect in the first effect repository using the identifier information of the effect group and the identifier of the effect, and
querying the effect in the second effect repository for the second region comprises querying the effect in the second effect repository using the identifier information of the effect group and the identifier of the effect.

10. A computing device, comprising:
at least one processing unit; and
at least one memory coupled to the at least one processing unit and storing thereon instructions executable by the at least one processing unit, wherein the instructions, when executed by the at least one processing unit, cause the computing device to perform the method that comprises:
obtaining a request for a template from a first region, wherein the request comprises an identifier of an effect in the template;
querying the effect in a first effect repository for the first region using the identifier of the effect;
querying the effect in a second effect repository for a second region using the identifier of the effect, the second region including the first region; and
sending the effect obtained from the first effect repository or the second effect repository as a response to the request.

11. The computing device of claim 10, wherein querying the effect in the second effect repository for the second region comprises:
in response to the effect not being found in the first effect repository and it being determined that the effect is configured to the second region, querying the effect in the second effect repository for the second region using the identifier of the effect.

12. The computing device of claim 10, wherein, in response to the effect not being found in the first effect repository and it being determined that the effect is not configured to the second region, it is determined that the template is unavailable.

13. The computing device of claim 10, the method further comprising:
in response to the effect being found in the first effect repository, sending the effect obtained from the first effect repository as the response to the request.

14. The computing device of claim 10, wherein the template is created based on a third effect repository for a third region, the third region being different from the first region.

15. The computing device of claim 14, wherein the first effect repository and the second effect repository comprise common effects, and comprise region-specific effects, respectively.

16. The computing device of claim 10, wherein the effect is included in an effect group, the request further comprises identifier information of the effect group, and determining whether the effect is configured to the second region comprises:
determining, based on a list of effect groups configured to the second region, that the effect group has a configuration for the second region; and
in response to determining that the effect group has the configuration for the second region, determining that the effect is configured for the second region.

17. The computing device of claim 16, wherein the effect group comprises a panel comprising at least one of: a font, dynamic text, a filter, a sticker, a mask and a transition.

18. The computing device of claim 16, wherein,
querying the effect in the first effect repository for the first region comprises querying the effect in the first effect repository using the identifier information of the effect group and the identifier of the effect, and
querying the effect in the second effect repository for the second region comprises querying the effect in the second effect repository using the identifier information of the effect group and the identifier of the effect.

19. A non-transitory computer storage medium storing thereon machine-executable instructions, wherein the machine-executable instructions, when executed by a device, cause the device to perform the method that comprises:
obtaining a request for a template from a first region, wherein the request comprises an identifier of an effect in the template;
querying the effect in a first effect repository for the first region using the identifier of the effect;
querying the effect in a second effect repository for a second region using the identifier of the effect, in response to determining that the effect is configured to the second region, the second region including the first region; and
sending the effect obtained from the first effect repository or the second effect repository as a response to the request.

20. The non-transitory computer storage medium of claim 19, wherein querying the effect in the second effect repository for the second region comprises:
in response to the effect not being found in the first effect repository and it being determined that the effect is configured to the second region, querying the effect in the second effect repository for the second region using the identifier of the effect; and
in response to the effect not being found in the first effect repository and it being determined that the effect is not configured to the second region, determining that the template is unavailable.
